(19) United States
(12) Patent Application Publication
(10) Pub. No.: US 2010/0107822 A1
(43) Pub. Date: May 6, 2010

(54) APPARATUS AND METHOD FOR MANUFACTURING IRON BLOCK USING IRON PIECES

(75) Inventor: Ki Yeoul Pyeon, Busan (KR)

Correspondence Address: LRK Patent Law Firm, 1952 Gallows Rd, Suite 200, Vienna, VA, 22182, US

(73) Assignee: IM STEEL CO., LTD., Yangsan (KR)

(21) Appl. No.: 12/593,774

(22) PCT Filed: Mar. 28, 2008
(86) PCT No.: PCT/KR2008/001752

§ 371 Date: Nov. 26, 2009

(30) Foreign Application Priority Data
Mar. 30, 2007 (KR) 10-2007-0031232

(51) Int. Cl. C22B 1/16; B29C 67/02

(52) U.S. Cl. 75/769; 425/222

(57) ABSTRACT

Disclosed herein is an apparatus and a method for manufacturing an iron block from iron pieces generated during a machining process. The apparatus includes: a hopper through which chip-shaped iron pieces are introduced; an agitator positioned below the hopper, which includes one or more inlets in an upper region thereof and an outlet in a lower region thereof, and which includes an impeller internally mounted on a center shaft and rotated therearound so as to agitate the iron pieces, silicate of soda and water introduced through the inlets; and a forming unit positioned below the outlet of the agitator and including a heating wire embedded in an inner wall thereof. The invention has advantages of minimized weight loss and increased hardness, and the moisture content contained in the iron block is minimized, thus avoiding a decrease in hardness attributable to corrosion during the storage and the transportation.

### TECHNICAL FIELD

The present invention relates to an apparatus and a method for manufacturing an iron block from iron pieces generated during a machining process, and, more particularly, to an apparatus and a method for manufacturing an iron block from iron pieces, which is adapted to mix iron pieces, generated in a process of machining machine components, with silicate of soda and water, agitate the mixture, and compress the mixture in a forming cavity while heating it, thus realizing an iron block having minimal weight loss and increased hardness.

### BACKGROUND ART

Generally, while various metal components including machine components are machined using a universal machine tool, a lathe or a milling machine, coiled iron pieces are continuously generated as a result of the cutting of the components.

Further, in steel plants and production sites, slag powder, which is residual mass generated in the production of metal products, is sprayed and accumulates around the production sites.

After the process of producing the metal product is completed, the metal residues, such as the iron pieces, are periodically collected and treated as reusable materials. Among these, coiled iron is crushed into a chip shape, and is then collected together with slag powder for the purpose of reuse. Hence, it is impossible to avoid an increase in weight and volume when transporting and storing the iron pieces, thus increasing the physical distribution costs and carrying charges.

Further, when the iron pieces are reused, the iron pieces in the form of powder are directly charged in a blast furnace, and then melt in the blast furnace, which is heated to a high temperature. At this point, some part of the charged iron pieces fly toward the inner wall of the blast furnace without melting, thus causing damage to the body wall of the blast furnace.

Accordingly, efforts have been made to find a way to manufacture the collected iron pieces into an iron block for the sake of the reduction of the volume and the easy transportation and storage thereof, and to melt the iron block in a blast furnace for reuse.

In such a conventional method of manufacturing an iron block, the iron pieces are mixed with water together with additional adhesive that is added as a solid formulation, and is then shaped into an aggregate, in which the solidification of the adhesive causes the formation of the iron block from the iron pieces. However, the conventional method is problematic in that the resulting iron block inevitably contains moisture therein, and thus the iron block is broken due to the moisture contained therein, after the forming and drying operations.

In order to overcome the above problem, a solution in which the amount of water that is mixed with the iron pieces is decreased whereas the amount of adhesive is increased may be used. In this case, it is problematic that the reuse ratio of the iron pieces is decreased because the content of the iron pieces is decreased in proportion with the increase in the use of the adhesive.

### DISCLOSURE OF INVENTION

### Technical Problem

Accordingly, the present invention has been made keeping in mind the above problems occurring in the conventional method of manufacturing an iron block using iron pieces, and an object of the present invention is to provide an apparatus and a method for manufacturing an iron block using iron pieces, which is adapted to mix iron pieces, which are generated in a process of machining machine components or which come from steel plants, with silicate of soda and water, agitate the mixture, and compress the mixture in a forming machine which applies a compressive load while heating the mixture therein, thus realizing an iron block with minimal weight loss, increased hardness and an increased recovery rate of iron pieces.

Another object of the present invention is to provide an apparatus and a method for manufacturing an iron block using iron pieces, which is intended to cause moisture in the iron block to evaporate due to high temperature heat at the time of compression of the iron piece mixture, so that the moisture content contained in the iron block is minimized, thus increasing compressive strength.

### Technical Solution

In order to accomplish the above object, the present invention provides an apparatus for manufacturing an iron block using iron pieces, including: a hopper through which chip-shaped iron pieces are introduced; an agitator positioned below the hopper, which includes one or more inlets in an upper region thereof and an outlet in a lower region thereof, and which includes an impeller internally mounted on a center shaft and rotated therearound so as to agitate the iron pieces, silicate of soda and water introduced through the inlets; and a forming unit positioned below the outlet of the agitator and including a heating wire embedded in an inner wall thereof.

The agitator may be configured to be cylindrical, and the one or more inlets, formed in the upper region of the agitator, may include a first inlet, through which the iron pieces are introduced into the agitator, and a second inlet, through which the silicate of soda and the water are introduced into the agitator in a form of a mixture.

The iron pieces, which are introduced into the agitator from the hopper trough the first inlet, are mixed with the silicate of soda and the water, which are introduced into the agitator through the second inlet, through the rotation of the impeller, and are then transferred to the cylindrical forming unit.

The forming unit has a cylindrical forming cavity formed therein, and a heating wire formed on a side wall thereof. Further, the forming unit has moisture-emitting holes for allowing the discharge of moisture.

Further, the forming unit includes a press, which is intended to compress and form the iron pieces mixture received in the forming cavity from above, thus providing a cylindrical iron block as a result of the vertical compression by the press.

Also, in order to accomplish the above object, the present invention provides a method of manufacturing an iron block using iron pieces, including: mixing silicate of soda with water into a form of mixture and agitating the mixture; introducing the mixture of the silicate of soda and the water into an agitator where the mixture is mixed with a predetermined amount of iron pieces thus forming a mixture, and agitating the mixture using an impeller rotating around a center shaft of the agitator; introducing the mixture with the iron pieces into a forming unit through an outlet of the agitator; compressing the mixture with the iron pieces in the forming unit using a press while heating the mixture to a predetermined temperature, thus providing a sintered iron block; and removing the compressed and sintered iron block from the forming unit.

The silicate of soda and the water in the mixture, which are introduced through the second inlet, may be mixed with each other in a mixing ratio of 1:4.

The mixture of the iron pieces, the silicate of soda and the water, introduced into the forming unit, may be compressed while being heated to a temperature of 200 to 600° C. using a heating wire embedded in the forming unit, and thus the moisture contained the iron piece mixture evaporates, thus providing a compact and strong iron block.

### ADVANTAGEOUS EFFECTS

As described above, the apparatus and the method for manufacturing an iron block using iron pieces, according to the present invention, is adapted to mix iron pieces with silicate of soda and water at an appropriate mixing ratio, and compressing the mixture in a forming machine equipped with a heating wire while heating it therein. Therefore, the present invention has advantages of minimized weight loss and increased hardness. Further, the present invention has an advantage in that the moisture content contained in the iron block is minimized, thus avoiding a decrease in hardness attributable to corrosion during the storage and the transportation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing an apparatus for manufacturing an iron block according to the present invention; and

FIG. 2 is a cross-sectional view showing a forming machine incorporated in the apparatus according to the present invention.

### DESCRIPTION OF REFERENCE NUMERALS FOR SUBSTANTIAL PARTS

10 hopper 20 agitator
22 center shaft 23 impeller
24 first inlet 25 second inlet
26 outlet 30 forming machine
31 heating wire 33 moisture-emitting hole

### BEST MODE FOR CARRYING OUT THE INVENTION

A better understanding of the technical construction and the effects of the apparatus and the method for manufacturing an iron block using iron pieces, according to the present invention, may be obtained through the following detailed description taken in conjunction with the accompanying drawings, which show the preferred embodiments of the present invention.

Apparatus for Manufacturing an Iron Block

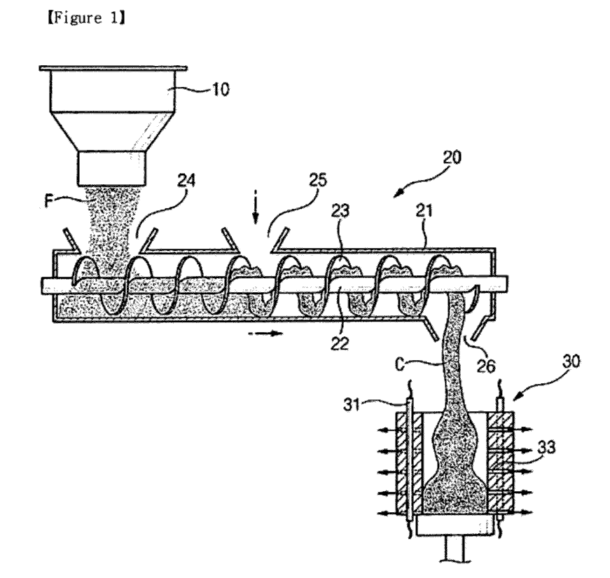

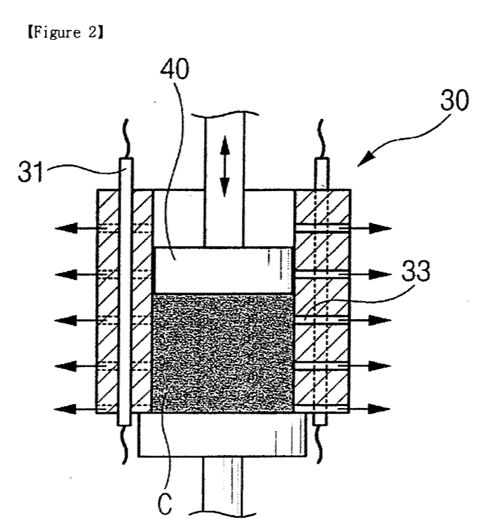

In the drawings, FIG. 1 is a schematic view showing an apparatus for manufacturing an iron block according to the present invention, and FIG. 2 is a cross-sectional view showing a forming machine incorporated in the apparatus according to the present invention.

As shown in the drawings, the apparatus for manufacturing an iron block, according to the present invention, comprises a hopper 10, an agitator 20, positioned immediately below the hopper 10 and having an impeller 23 mounted on a center shaft 22 and rotated therearound, and a forming machine 30 positioned immediately below an end of the agitator 20 and in which an iron piece mixture “C”, which is mixed in the agitator 20, is introduced.

The chip-shaped iron pieces “F” are introduced into the hopper 10, and among the iron pieces, a predetermined amount of iron pieces is put into the agitator 20, which is positioned immediately below the hopper 10.

The agitator 20, in which the iron pieces “F” are introduced, is configured to be cylindrical, such that a first inlet 24 and a second inlet 25 are formed on the upper area of the agitator and an outlet 26 is formed on an end of the agitator.

In the agitator 20, the iron pieces “F”, which are introduced into the agitator 20 through the first inlet 24, are agitated and moved by the impeller 23 rotating around the center shaft 22. During the movement along the impeller 23 in the agitator 20, the iron pieces are further mixed with a mixture comprised of water and silicate of soda, and the iron pieces and the mixture result in an iron piece mixture “C” through the continuing rotation of the impeller 23.

In the introduction of the mixture of water and silicate of soda, the water and the silicate of soda may be introduced either in a manner such that the water and the silicate of soda are concurrently introduced into the agitator 20 through the second inlet 25 and then mixed therein, or in a manner such that the water and the silicate of soda are separately mixed into a mixture in advance and then the mixture is introduced into the agitator 25 through the second inlet 25 and mixed with the iron pieces “C”.

In this regard, the silicate of soda may be sodium silicate, and may be classified into sodium metasilicate (Na₂SiO₃) and hydrates thereof, e.g. sodium orthosilicate (Na₄—Si₂O₄) and sodium disilicate (Na₂Si₂O₅), depending on the composition. The silicate of soda is usually sodium metasilicate. The silicate of soda may be used in the form of a hydrate, and an anhydride such as typical glass is manufactured by heating and melting a mixture of quartz and sodium carbonate to a temperature of 1000 degrees Celsius and then solidifying it. An aqueous solution of the silicate of soda is hydrolyzed into a rich solution of sodium silicate (2Na₂SiO₃+H₂O=Na₂SiO₅+2NaOH), which is typically referred to as liquid glass.

The mixture of water and silicate of soda, which is introduced into the agitator 20 through the second inlet 25, is presented in the form of a liquid composition which is prepared by mixing silicate of soda and water in a ratio of 1:4. The silicate mixture is mixed with the iron pieces “F”, which are introduced through the first inlet 24, at a ratio of 1:15 to 1:30.

The iron piece mixture “C”, which is prepared by mixing the materials in the above mixing ratio and agitating it, is introduced into the forming machine 30 through the outlet 26 of the agitator 20. The iron piece mixture “C”, which is introduced into the forming machine 30, is compressed using the vertical load generated by a press 40, which is positioned on the forming machine 30 and moves downwards.

The compressive force, which is applied to the iron piece mixture “C” by the press 40, may vary depending on the degree of agitation and the density of the chip-shaped iron pieces constituting the iron piece mixture “C”. The iron piece mixture “C” is heated to a temperature ranging from 200 to 600 degree Celsius by a heating wire 31 embedded in the inner wall of the forming machine 30 at the same time as the compression by the press 40.

Consequently, the iron piece mixture “C” received in the forming machine 30 exudes moisture therefrom through the compression by the press 40, and the exuded moisture is discharged outside through moisture-emitting holes 33 formed in the forming machine 30.

Further, since the iron piece mixture “C” is compressed by the press 40 while being heated by the heat applied to the side surface thereof, the moisture contained in the compressed mixture is evaporated, and the evaporated moisture is discharged outside through the moisture-emitting holes 33 formed in the lateral wall of the forming machine 30.

More specifically, as the iron piece mixture “C” received in the forming machine 30 is compressed at a predetermined pressure while being heated, the moisture contained in the iron piece mixture “C” is removed, and thus the remaining silicate of soda is solidified. As a result of the solidification of the silicate of soda, the cohesive force in the iron piece mixture “C” is increased, and in addition, an iron block, which has increased hardness attributable to the minimization of moisture content in the compressed iron piece mixture “C” is produced.

Method of Manufacturing an Iron Block

The method of manufacturing an iron block using the above-described apparatus, according to the present invention, includes a first agitation process in which silicate of soda and water are mixed with each other and the silicate mixture is agitated, and a second agitation process in which the silicate mixture is introduced into the agitator 20 where the silicate mixture is mixed with iron pieces, resulting in an iron piece mixture “C”.

In addition, the method includes an introduction process in which the iron piece mixture “C”, which is prepared in the agitator 20, that is, the iron piece mixture “C”, which is prepared by mixing the water and the silicate of soda at a predetermined ratio in the agitator 20, is discharged outside, and the discharged iron piece mixture “C” is introduced into the forming machine 30, a compressive forming process, in which the predetermined amount of iron piece mixture “C” charged in the forming machine 30 is heated to a predetermined temperature while being compressed by the press 40, and a separation process, in which the compressed iron block is removed from the forming machine 30.

In this method, the silicate of soda and the water, which are present in a ratio of 1:4, may be concurrently introduced through the second inlet 25 into the agitator 20, where they are mixed with each other. Alternatively, prior to the introduction into the agitator 20, the silicate of soda and the water may be mixed into a silicate mixture by a separate agitator (not shown), and then the silicate mixture may be introduced into the agitator 20 through the second inlet 25.

Through the first inlet 24, positioned upstream of the second inlet 25, iron pieces “F”, which are present in a ratio of 1:15 to 1:30 with respect to the silicate mixture, are introduced into the agitator 20 from the hopper 10, and the iron pieces “F” introduced in the agitator 20, are horizontally transferred toward the outlet 26 along the impeller 23, which is rotated around the center shaft 22.

The iron piece mixture “C”, which is prepared by the homogeneous mix of the water, silicate of soda and the iron pieces, is discharged outside through the outlet 26, and is then charged in the forming machine 30, which is positioned immediately below the outlet 26.

The iron piece mixture “C”, which is charged in the forming machine 30, is heated by the heating wire 31 embedded in the inner wall of the forming machine 30, and thus the moisture contained in the iron piece mixture “C” evaporates. At the same time, the iron piece mixture “C” is compressed by the press 40 positioned on the forming machine 30, and thus the moisture in the iron piece mixture “C” is discharged outside, thus realizing a desired iron block which has minimal moisture content and high hardness.

The iron blocks, which are manufactured by the apparatus and the method according to the present invention, were taken as samples, and were tested at the Korea Institute of Industrial Technology. The results of the tests are presented as tensile strength and hardness in Table 1 below.

Table 1

TABLE 1

| | Diameter | Tensile | Brinell |
|---|---|---|---|
| Sample No. | (mm) | Strength(N/mm²) | Hardness(HBW 10/3000) |
| 1-1 | 19.99 | 325 | 215 |
| 1-2 | 19.99 | 328 | 217 |

* Test standard: KS B 0801(No. 8), 0802, 0805
* Charging ratio of sample: pig iron 30%, steel scraps 19%, compressed machined chip briquet 50%, alloy iron 1%

As apparent from Table 1, an iron block manufactured by compressing and forming a large amount of iron pieces, according to the present invention has a tensile strength and a hardness, which are comparable to those of a usual steel ingot, even if the iron block is manufactured using various kinds of iron pieces.

After one of the samples is melted in a furnace, the recovery rate of the sample is found. The results of the recovery rate after melting are presented in Table 2 below.

Table 2

TABLE 2

| | Charging | Weight after | Recovery |
|---|---|---|---|
| Sample No. | weight(kg) | melting(kg) | rate(%) |
| 1 | 52.254 | 52.200 | 99.89 |

* Test method: melting in a high-frequency induction melting furnace
* Sample: compressed machined chip briquet

As apparent from Table 2, the iron block manufactured by the method according to the present invention contains minimal moisture content. Consequently, it is noted that the ratio of the weight of the melted iron recovered from the furnace to the weight of the iron pieces charged in the forming machine 30, i.e., the recovery rate, is almost 99.9%. Accordingly, it is appreciated that there is almost no melting loss caused by defects in the internal texture of the iron block, which is manufactured using iron pieces.

Although the preferred embodiments of the present invention have been disclosed for illustrative purposes, those skilled in the art will appreciate that various modifications, additions and substitutions are possible, without departing from the scope and spirit of the invention as disclosed in the accompanying claims, and that the modifications, additions and substitutions also fall within the scope of the invention.

1. An apparatus for manufacturing an iron block using iron pieces, comprising:
a hopper through which chip-shaped iron pieces are introduced;
an agitator positioned below the hopper, which includes one or more inlets in an upper region thereof and an outlet in a lower region thereof, and which includes an impeller internally mounted on a center shaft and rotated therearound so as to agitate the iron pieces, silicate of soda and water introduced through the inlets; and
a forming unit positioned below the outlet of the agitator and including a heating wire embedded in an inner wall thereof.

2. The apparatus according to claim 1, wherein the agitator is configured to be cylindrical, and wherein the one or more inlets, formed in the upper region of the agitator, includes a first inlet, through which the iron pieces are introduced into the agitator, and a second inlet, through which the silicate of soda and the water are introduced into the agitator in a form of a mixture.

3. The apparatus according to claim 1, wherein the forming unit is configured to be cylindrical, and includes a moisture-emitting hole through which an inside thereof communicates with an outside thereof.

4. The apparatus according to claim 1, wherein the silicate of soda and the water are mixed with each other in a mixing ratio of 1:4.

5. The apparatus according to claim 1, wherein the mixture of the silicate of soda and the water, which is introduced through the second inlet, and the iron pieces, which are introduced through the first inlet, are mixed with each other in a mixing ratio of 1:15 to 1:30, and are agitated in the agitator.

6. The apparatus according to claim 1, wherein the forming unit heats the mixture of the iron pieces, the silicate of soda and the water, received therein, to a temperature of 200 to 600° C. using the heating wire embedded in the inner wall.

7. A method of manufacturing an iron block using iron pieces, comprising:
mixing silicate of soda with water into a form of mixture and agitating the mixture;
introducing the mixture of the silicate of soda and the water into an agitator where the mixture is mixed with iron pieces thus forming a mixture, and agitating the mixture using an impeller rotating around a center shaft of the agitator;
introducing the mixture with the iron pieces into a forming unit through an outlet of the agitator;
compressing the mixture with the iron pieces in the forming unit using a press while heating the mixture, thus providing a sintered iron block; and
removing the compressed and sintered iron block from the forming unit.

8. The method according to claim 7, wherein, in the introducing the mixture of the silicate of soda and the water, the iron pieces are introduced into the agitator through a first inlet of the agitator from a hopper, and the mixture of the silicate of soda and the water is introduced into the agitator through a second inlet of the agitator.

9. The method according to claim 7, wherein, in the compressing the mixture, moisture contained in the mixture is discharged outside through a moisture-emitting hole, which is formed in the forming unit and through which an inside thereof communicates with an outside thereof.

10. The method according to claim 8, wherein the silicate of soda and the water in the mixture, which are introduced through the second inlet, are mixed with each other in a mixing ratio of 1:4.

11. The method according to claim 8, wherein the mixture of the silicate of soda and the water, which is introduced through the second inlet, and the iron pieces, which are introduced through the first inlet, are mixed with each other in a mixing ratio of 1:15 to 1:30, and are agitated in the agitator.

12. The apparatus according to claim 9, wherein the mixture of the iron pieces, the silicate of soda and the water, received in the forming unit, is heated to a temperature of 200 to 600° C. using a heating wire embedded in the forming unit.

13. The apparatus according to claim 2, wherein the silicate of soda and the water are mixed with each other in a mixing ratio of 1:4.

14. The apparatus according to claim 2, wherein the mixture of the silicate of soda and the water, which is introduced through the second inlet, and the iron pieces, which are introduced through the first inlet, are mixed with each other in a mixing ratio of 1:15 to 1:30, and are agitated in the agitator.
